(19) United States
(12) Patent Application Publication
(10) Pub. No.: US 2003/0142384 A1
(43) Pub. Date: Jul. 31, 2003

(54) Optical transmission apparatus

(75) Inventor: Rintaro Kurebayashi, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/350,062

(22) Filed: Jan. 24, 2003

(30) Foreign Application Priority Data
Jan. 31, 2002 (JP) 2002-022716

(51) Int. Cl. G02F 1/00

(52) U.S. Cl. 359/237

(57) ABSTRACT

Light with a single wavelength is generated from a light source 1. Optical phase modulators 2-4 are connected to the light source 1 in series. The optical phase modulators 2-4 modulate an optical phase in accordance with an electrical signal externally inserted. The phase modulation is performed so that the phase is shifted by 0.5π with respect to a predetermined reference phase for each bit of a transmission data signal. Optical intensity modulators 5, 6 are connected to each other in series at a subsequent stage of the optical phase modulator 4. The optical intensity modulators 5, 6 modulate optical intensity in accordance with an electrical signal externally inserted.

### BACKGROUND OF THE INVENTION

1. Field of the Invention

The present invention relates to an optical transmission apparatus for optical fiber transmission, and particularly to an optical transmission apparatus for an optical fiber transmission used in a high capacity or long distance optical transmission system.

2. Description of Related Art

Recently, it has become clear from the results of much research that a modulation method for a transmission optical signal plays an important role in a high capacity or long distance optical transmission system.

Among these results, a simulation result has been reported at The 2000 Institute of Electronics, Information and Communication Engineers General Conference B-10-90 which shows that a bit synchronous π/2 phase shift RZ (Return to Zero) signal as a modulation method for preventing interference between adjacent bits is effective in transmission and particularly at a bit rate of 40 Gb/s.

This report shows through the simulation that the use of bit synchronous π/2 phase shift RZ improves transmission characteristics further than a carrier suppressed RZ modulation method widely used at present as being effective in transmission at a bit rate of 40 Gb/s, where a phase between adjacent channels is shifted by π.

However, there have been no examples generated actually so far of a signal of which phase between bits is shifted by π/2 and there is a carrier suppressed RZ modulation signal and the like of which phase between adjacent bits is shifted by π for the modulated optical signal of which optical phase between adjacent bits differs.

Regarding such a method for generating a modulated optical signal in which optical phase between adjacent bits differs, there exists no apparatus that generates the modulated optical signal by directly applying phase modulation to light with an external electrical signal.

### SUMMARY OF THE INVENTION

A first object of the present invention is to provide an optical transmission apparatus for optical fiber transmission that solves the aforementioned problem, and that is capable of easily generating a signal of which phase between adjacent bits is shifted by π/2 without the use of a new optical device, and to make measured improvement of high bit rate transmission characteristics.

The optical transmission apparatus of the present invention is an optical transmission apparatus that modulates an input optical signal to output a modulated optical signal. The optical transmission apparatus includes an optical phase modulator, which applies phase modulation to an input light to be outputted, and an optical intensity modulator, which applies intensity modulation to an input to be outputted in accordance with a transmission data signal. The optical phase modulator and optical intensity modulator are cascade-connected to each other, and phase modulation is performed so that the phase is shifted by 0.5π with respect to a predetermined reference phase for each bit of the transmission data signal.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram illustrating a configuration of an optical transmission apparatus for optical fiber transmission according to a first embodiment of the present invention;

FIG. 2 is a diagram illustrating an operation of the optical transmission apparatus for optical fiber transmission according to the first embodiment of the present invention;

FIG. 3 is a block diagram illustrating a configuration of an optical transmission apparatus for optical fiber transmission according to a second embodiment of the present invention;

FIG. 4 is a diagram illustrating an operation of the optical transmission apparatus for optical fiber transmission according to the second embodiment of the present invention;

FIG. 5 is a block diagram illustrating a configuration of an optical transmission apparatus for optical fiber transmission according to a third embodiment of the present invention; and

FIG. 6 is a diagram illustrating an operation of the optical transmission apparatus for optical fiber transmission according to the third embodiment of the present invention.

### DETAILED DESCRIPTION OF THE PREFERRED EMBODIMENTS

(First Embodiment)

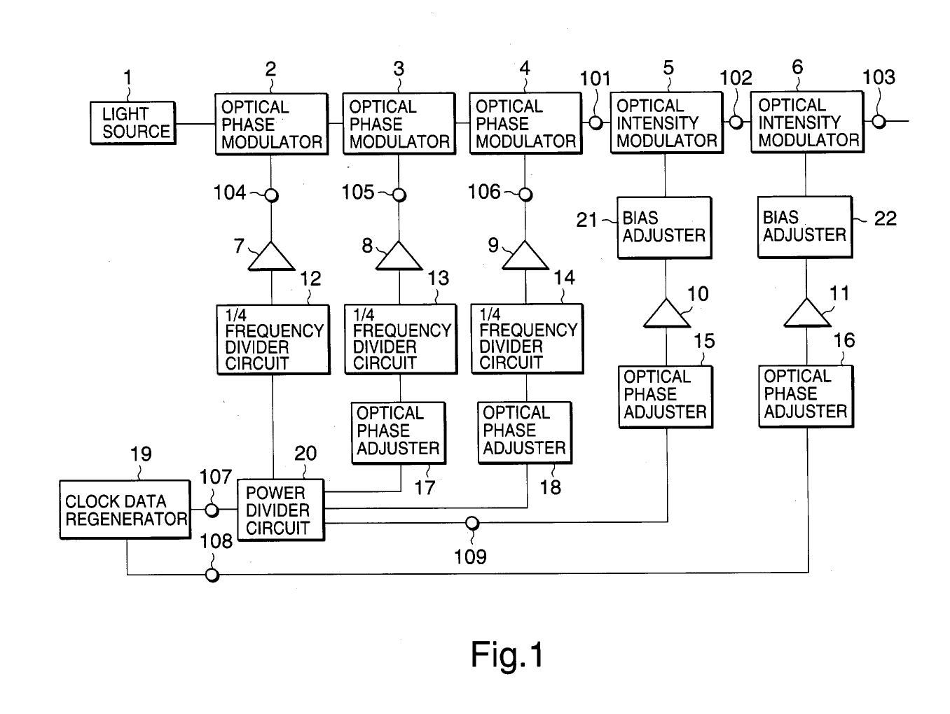

Embodiments of the present invention will be explained with reference to the drawings. FIG. 1 is a block diagram illustrating a configuration of an optical transmission apparatus for optical fiber transmission according to a first embodiment of the present invention. In FIG. 1, the optical transmission apparatus for optical fiber transmission according to the first embodiment of the present invention includes a light source 1, optical phase modulators 2 to 4, optical intensity modulators 5 and 6, amplifiers 7 to 11, ¼ frequency divider circuits 12 to 14, optical phase adjusters 15 to 18, a clock data regenerator 19, a power divider circuit 20, and bias adjusters 21 and 22.

First, configuration of an optical modulation circuit will be explained. In FIG. 1, light with a single wavelength is generated from a light source 1. Optical phase modulators 2 to 4 are connected in series to the light source 1, and each of these optical phase modulators 2 to 4 has a function of modulating a phase of light in accordance with an electrical signal externally inserted. The optical intensity modulators 5, 6 are connected in series at the subsequent stage of the optical phase modulator 4, and each of the optical intensity modulators 5 and 6 has a function of modulating intensity of light in accordance with the electrical signal externally inserted.

An explanation will be next given of the circuit configuration of the electrical signal. First, data and a clock signal are regenerated from an input data signal by the clock data regenerator 19. The regenerated clock signal is divided into four by the power divider circuit 20. Three of the signals divided by the power divider circuit 20 are used as external signals for optical phase modulation, and one is used as an external electrical signal for intensity modulation.

Moreover, three of the four clock signals divided by the power divider circuit 20 are connected to the optical phase adjusters 15, 17, and 18. Each of these optical phase adjustors 15, 17 and 18 has a function of shifting the phase of the electrical signal.

While, the clock signals used as external signals for optical phase modulators 2 to 4 are divided and deformed to rectangular pulses each having a ¼ period by the ¼ frequency divider circuits 12 to 14, respectively. The ¼ frequency divider circuits 12 to 14 are connected to the amplifiers 7 to 9 at the subsequent stage, respectively. Each of the amplifiers 7 to 9 has a function of adjusting output amplitude, and signals of which output amplitude adjusted by the amplifiers 7 to 9 are inserted to the optical phase adjusters 2 to 4 as external electrical signals for optical phase adjustment, respectively.

Furthermore, the optical phase adjuster 15 is connected to the amplifier 10. The output of the clock signal is adjusted by the amplifier 10, and the adjusted output is inserted to the optical intensity modulator 5 as an external signal for optical intensity modulation via the bias adjuster 21.

The data signals regenerated by the clock data generator 19 are connected to the optical phase modulator 16 and amplifier 11 sequentially. The data signal of which phase and amplitude are adjusted is inserted to the optical intensity modulator 6 as an external signal for optical intensity modulation via the bias adjuster 22.

In the aforementioned configuration, in principle, even if the connection sequence of the optical phase modulators 2 to 4 and that of the optical intensity modulators 5 and 6 are changed, there is no problem in generation of modulated signals. However, in the case where the connection sequence is changed, the external electrical signals to be respectively inserted to the optical phase modulators 2 to 4 and optical intensity modulators 5 and 6 must be changed accordingly.

Moreover, in the case where loss in the optical phase modulators 2 to 4 or that of the optical intensity modulators 5 and 6 is large, at least one optical amplifier (polarization maintaining type optical amplifier is used depending on the optical phase modulator or optical intensity modulator) is inserted at any position between optical modulator 2 and optical intensity modulator 6 and thereafter, which are connected in series to virtually reduce passage loss generated in the transmission apparatus.

Furthermore, even if the connection sequences of the optical phase adjusters 15 to 18 connected in series to the external electrical signal, that of ¼ frequency divider circuits 12 to 14 and that of the amplifiers 7 to 11 are changed, no influence is exerted upon the modulated signal.

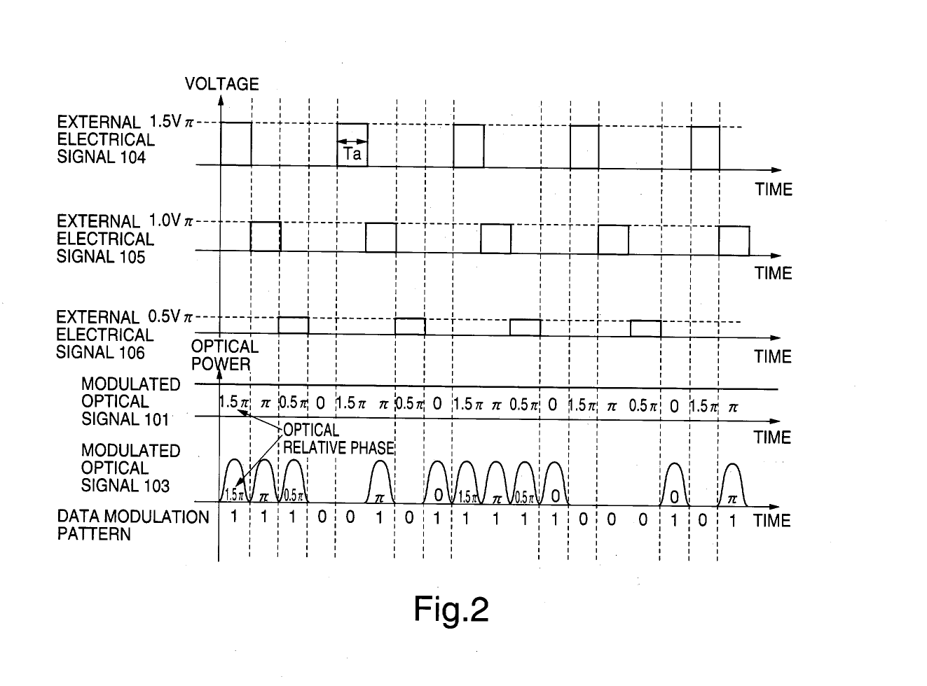

FIG. 2 is a diagram illustrating an operation of the optical transmission apparatus for optical fiber transmission according to the first embodiment of the present invention. With reference to FIG. 1 and FIG. 2, the operation of the aforementioned circuit configuration will be explained. In FIG. 1, light with fixed amplitude and a single wavelength generated from the light source 1 is subjected to phase modulation through the optical phase modulators 2 to 4.

An external electrical signal 104 shown in FIG. 2 is inserted to the optical phase modulator 2. The external electrical signal 104 is a rectangular pulse signal, which is generated every four bits and which is equal to a bit slot width TB of the modulated optical signal, and the amplitude thereof is 1.5 Vπ (Vπ is a voltage necessary for shifting the phase by π). The external electrical signal 104 is generated by performing frequency division and amplitude adjustments to the clock signal regenerated by the clock data regenerator 19 using the ¼ frequency divider circuit 12 and the amplifier 7.

An external electrical signal 105 shown in FIG. 2 is inserted to the optical phase modulator 3. The external electrical signal 105 is a rectangular pulse signal with a pulse width TB generated every four bits. This pulse signal is generated at timing delayed by time corresponding to one bit slot with respect to the external electrical signal 104 by using the optical phase adjuster 17. Moreover, the external electrical signal 105 is generated by adjusting the output from the amplifier 8 so that the amplitude thereof becomes 1.0 Vπ.

An external electrical signal 106 shown in FIG. 2 is inserted to the optical phase modulator 4. The external electrical signal 106 is a rectangular pulse signal with a pulse width TB generated every four bits. This pulse signal is generated at timing delayed by time corresponding to one bit slot with respect to the external electrical signal 105 by using the optical phase adjuster 18. Moreover, the external electrical signal 106 is generated by adjusting the output from the amplifier 9 so that the amplitude thereof reaches 0.5 Vπ.

In a modulated optical signal 101 subjected to phase modulation by the aforementioned external electrical signals 104 to 106, light of which optical phase is shifted by π/2 every bit slot is generated as shown in FIG. 2. Note that, this embodiment shows the operation when the optical phase is delayed each time by π/2 along the passage of time. However, the phases of the external electrical signals 105 and 106 are adjusted by the same operation principle, thus making it possible for the optical phase to advance by π/2 with passage of time.

The modulated optical signal 101 is subjected to intensity modulation through the optical intensity modulators 5 and 6. In the optical intensity modulators 5 and 6, the modulated optical signal 101 is subjected to RZ modulation and data modulation as shown in FIG. 2, respectively, thus making it possible to obtain a modulated optical signal 103 of which optical phase between bits is shifted by π/2 as shown in FIG. 2.

Thus, in this embodiment, the optical modulation circuit can be attained with a simple configuration in which the optical phase modulators 2 to 4 and the optical intensity modulation adjusters 5 and 6 are merely cascade-connected to each other. This makes it possible to easily generate a signal of which phase between adjacent bits is shifted by π/2.

Moreover, in this embodiment, a signal of which phase between adjacent bits is shifted by π/2 is generated thus making it possible to reduce interference between adjacent bits caused by dispersion and non-linearity of fibers in the optical fiber transmission. As a result, it is possible to improve a high bit rate transmission characteristics of the optical signal transmission with 40 Gbit/s and the like.

Moreover, in this embodiment, the aforementioned circuit can be realized by simply combining the devices conventionally used, eliminating the need for new optical devices.

(Second Embodiment)

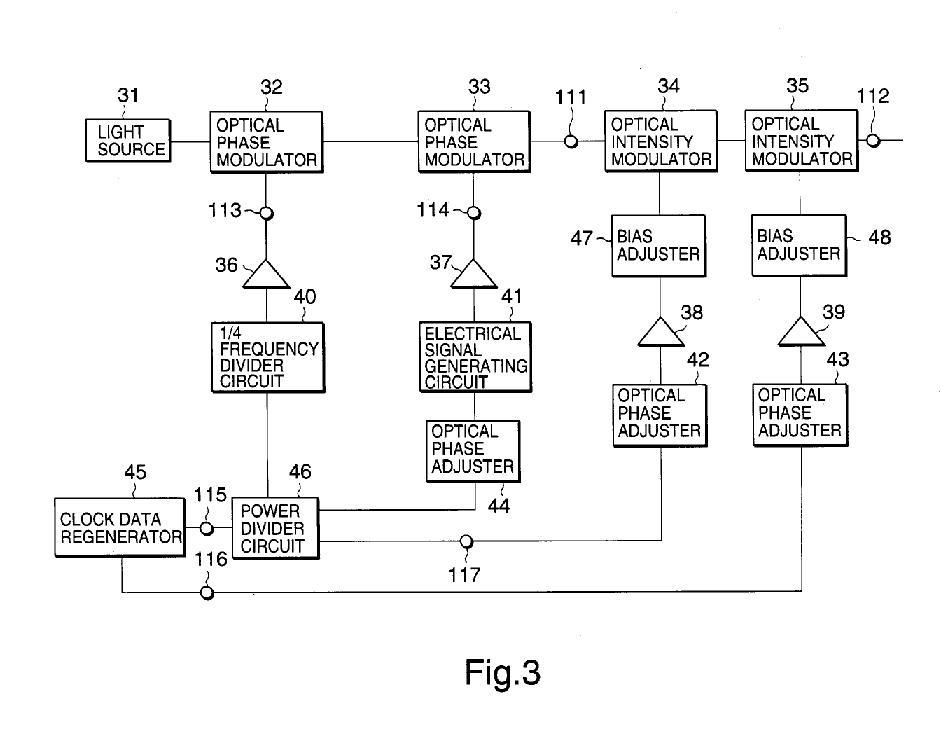

FIG. 3 is a block diagram illustrating a configuration of an optical transmission apparatus for optical fiber transmission according to a second embodiment of the present invention. In FIG. 3, for the optical fiber transmission in the optical transmission apparatus as shown in another embodiment of the present invention, the optical phase modulators are configured in two stages.

In other words, the optical transmission apparatus for optical fiber transmission of the second embodiment of the present invention includes a light source 31, optical phase modulators 32 and 33, optical intensity modulators 34 and 35, amplifiers 36 to 39, a ¼ frequency divider circuit 40, an electrical signal generation circuit 41, optical phase adjusters 42 to 44, a clock data regenerator 45, a power divider circuit 46, and bias adjusters 47 and 48.

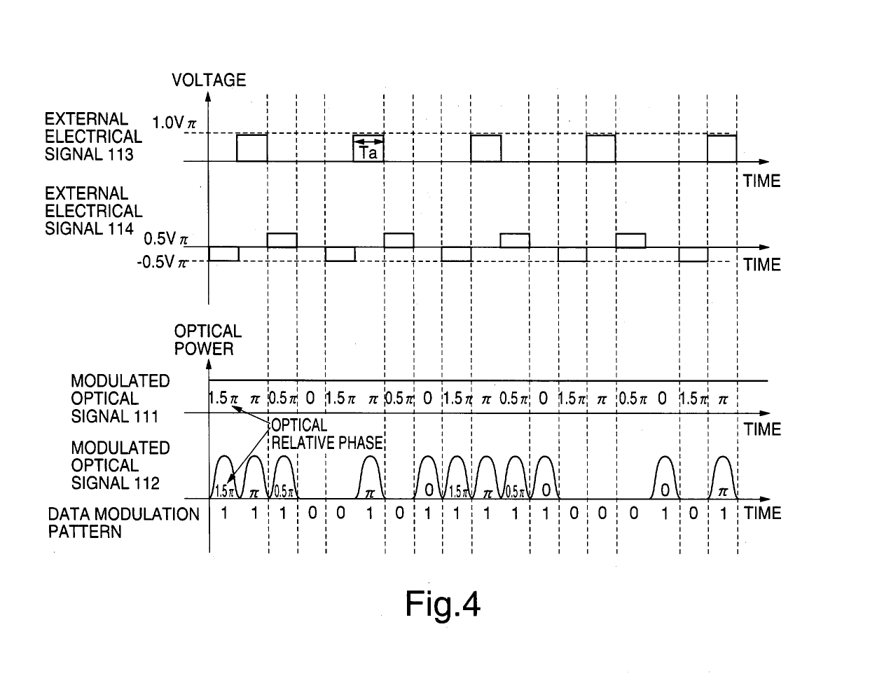

FIG. 4 is a diagram illustrating an operation of the optical transmission apparatus for optical fiber transmission according to the second embodiment of the present invention. With reference to FIG. 3 and FIG. 4, the operation of the aforementioned circuit configuration will be explained.

An external electrical signal 113 shown in FIG. 4 is inserted to the optical phase modulator 32. The external electrical signal 113 is a rectangular pulse signal, which is generated every four bits and which is equal to a bit slot width TB of the modulated optical signal, and amplitude thereof is 1.0 V π (Vπ is a voltage necessary for shifting the phase by π). The external electrical signal 113 is generated by performing frequency division and amplitude adjustments to a clock signal regenerated by the clock data regenerator 19 by using the ¼ frequency divider circuit 40 and amplifier 36.

An external electrical signal 114 shown in FIG. 4 is inserted to the optical phase modulator 33. The external electrical signal 114 is a rectangular pulse signal with a pulse width TB generated every two bits. This pulse signal is generated at timing, which is delayed or advanced by time corresponding to one bit slot with respect to the external electrical signal 113 by using the electrical signal generation circuit 41. Moreover, the external electrical signal 114 is generated by adjusting the output of the amplifier 36 so that the amplitude thereof reaches 1.0 Vπ (0.5 Vπ to −0.5 Vπ).

Accordingly, it is possible to generate a modulated optical signal of which optical phase between adjacent bits is shifted by π/2 as in the case of the modulated optical signal obtained by the aforementioned first embodiment of the present invention.

Such a configuration makes the generation of external electrical signal 114 complicated. However, since the number of phase modulators is reduced by one, passage loss caused by the optical transmission apparatus can be reduced.

(Third Embodiment)

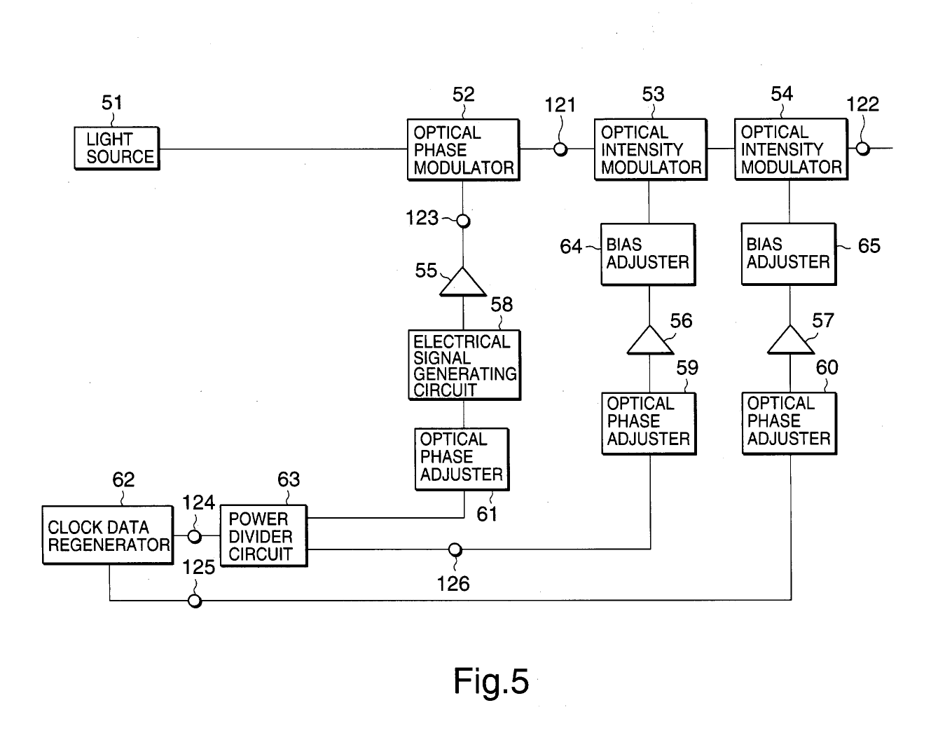

FIG. 5 is a block diagram illustrating a configuration of an optical transmission apparatus for optical fiber transmission according to a third embodiment of the present invention. In FIG. 5, for optical fiber transmission in the optical transmission apparatus of this embodiment, the optical phase modulator is configured in one stage.

The optical transmission apparatus for optical fiber transmission of this embodiment includes a light source 51, optical phase modulator 52, optical intensity modulators 53 and 54, amplifiers 55 to 57, an electrical signal generation circuit 58, optical phase adjusters 59 to 61, a clock data regenerator 62, a power divider circuit 63, and bias adjusters 64 and 65.

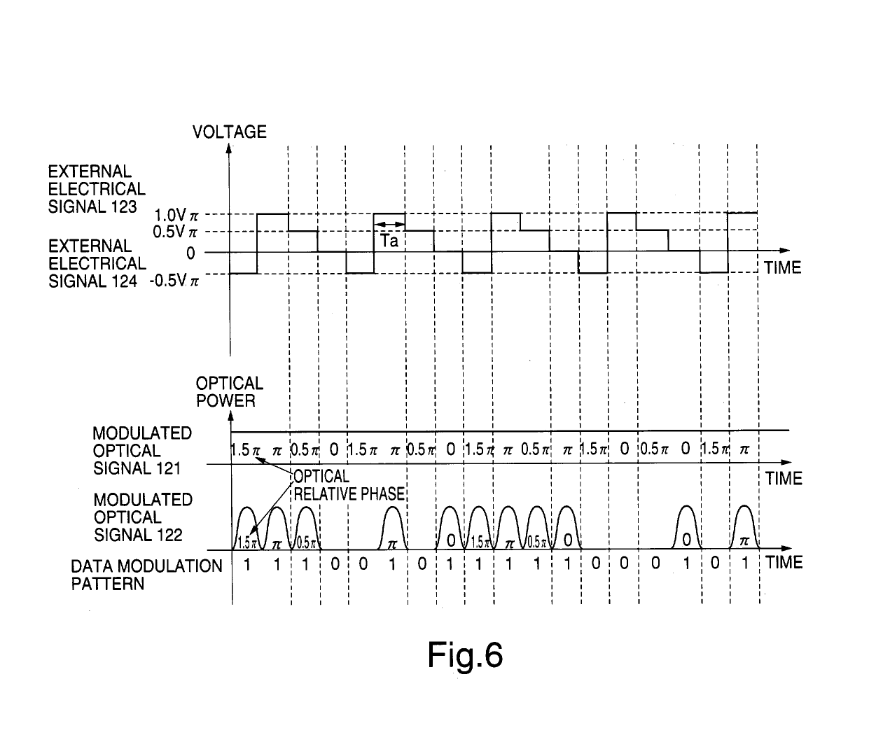

FIG. 6 is a diagram illustrating an operation of the optical transmission apparatus for optical fiber transmission according to this embodiment. With reference to FIG. 5 and FIG. 6, the operation of the aforementioned circuit configuration will be explained.

In FIG. 5, an external electrical signal 123 shown in FIG. 6 is inserted to the optical phase modulator 52. An external electrical signal 123 is a rectangular pulse signal, which is equal to a bit slot width TB of the modulated optical signal, and amplitude thereof is 1.5 Vπ (Vπ is a voltage necessary for shifting the phase by π) (1.0 Vπ to −0.5 Vπ). The external electrical signal 123 is generated by performing frequency division and amplitude adjustments to the clock signal regenerated by the clock data regenerator 62 by using the electrical signal generation circuit 58 and amplifier 55.

Accordingly it is possible to generate a modulated optical signal 122 of which phase is shifted by π/2 every bit shown in FIG. 6 as in the case of the aforementioned first and second embodiments.

Such a configuration makes it difficult to generate the external electrical signal 123 in the case where the modulated optical signal with a high bit rate is generated. However, if the external electrical signal 123 can be generated, it is possible to reduce passage loss of light in comparison to the case in which the plurality of phase modulators is connected in series.

As explained above, by use of the present invention, it is possible to generate a signal of which phase between adjacent bits is shifted by π/2 easily without using a new optical device whereby it is possible to improve high bit rate transmission characteristics.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the sprit and scope of the following claims.

What is claimed is:

1. An optical transmission apparatus which modulates an input optical signal to output a modulated optical signal, the optical transmission apparatus comprising:
an optical phase modulator which applies phase modulation to an input light to be outputted; and
an optical intensity modulator which applies intensity modulation to the input light to be outputted in accordance with a transmission data signal,
wherein the optical phase modulator and the optical intensity modulator are cascade-connected to each other, and the phase modulation is applied such that phase thereof is shifted by 0.5 π with respect to a predetermined reference phase for each bit of the transmission data signal.

2. The optical transmission apparatus according to claim 1, wherein the transmission data signal is a RZ code.

3. The optical transmission apparatus according to claim 1, wherein the optical intensity modulator includes a first and a second intensity modulating units cascade-connected to each other, and the first intensity modulating unit performs modulation based on the transmission data signal, and the second intensity modulating unit performs modulation based on a clock signal synchronized with the transmission data signal.

4. The optical transmission apparatus according to claim 1, wherein the optical phase modulator includes at least three phase modulating units cascade-connected to each other, and at least three of the phase modulating units provide phase shifts of 0.5π, π, and 1.5π with respect to a predetermined reference phase to the input light with each different bit of the transmission data signal.

5. The optical transmission apparatus according to claim 4, wherein the optical intensity modulator and the optical phase modulator are connected to each other such that the input optical signal is input to the optical phase modulator and the modulated optical signal is outputted from the optical intensity modulator.

6. The optical transmission apparatus according to claim 4, wherein the optical intensity modulator and optical phase modulator are connected to each other so that the input optical signal is input to the optical intensity modulator and the modulated optical signal is outputted from the optical phase modulator.

7. The optical transmission apparatus according to claim 4, wherein the optical intensity modulator includes a first and a second intensity modulating units cascade-connected to each other, and the first intensity modulating unit performs modulation based on the transmission data signal, and the second intensity modulating unit performs modulation based on a clock signal synchronized with the transmission data signal.

8. The optical transmission apparatus according to claim 1, wherein the optical phase modulator includes first and second phase modulating units cascade-connected to each other, and the first phase modulating unit provides phase shifts of 0.5π and −0.5π with respect to a predetermined reference phase to the input light with each different bit of the transmission data signal, and the second phase modulating unit provides a phase shift of π with respect to a predetermined reference phase to the input light with bits different from bits to which the first phase modulating unit performs phase modulation.

9. The optical transmission apparatus according to claim 8, wherein the optical intensity modulator and the optical phase modulator are connected to each other such that the input optical signal is input to the optical phase modulator and the modulated optical signal is outputted from the optical intensity modulator.

10. The optical transmission apparatus according to claim 8, wherein the optical intensity modulator and the optical phase modulator are connected to each other such that the input optical signal is input to the optical intensity modulator and the modulated optical signal is outputted from the optical phase modulator.

11. The optical transmission apparatus according to claim 8, wherein the optical intensity modulator includes a first and a second intensity modulating units cascade-connected to each other, and the first intensity modulating unit performs modulation based on the transmission data signal, and the second intensity modulating unit performs modulation based on a clock signal synchronized with the transmission data signal.

12. The optical transmission apparatus according to claim 1, wherein the optical phase modulator provides phases of 0π, 0.5π, π and 1.5π with respect to a predetermined reference phase to each bit of the transmission data signal.

13. The optical transmission apparatus according to claim 12, wherein the optical intensity modulator and the optical phase modulator are connected to each other such that the input optical signal is input to the optical phase modulator and the modulated optical signal is outputted from the optical intensity modulator.

14. The optical transmission apparatus according to claim 12, wherein the optical intensity modulator and optical phase modulator are connected to each other such that the input optical signal is input to the optical intensity modulator and the modulated optical signal is outputted from the optical phase modulator.

15. The optical transmission apparatus according to claim 12, wherein the optical intensity modulator includes a first and a second intensity modulating units cascade-connected to each other, and the first intensity modulating unit performs modulation based on the transmission data signal, and the second intensity modulating unit performs modulation based on a clock signal synchronized with the transmission data signal.

16. The optical transmission apparatus according to claim 12, wherein the optical intensity modulator includes a first and a second intensity modulating units cascade-connected to each other, and the first intensity modulating unit performs modulation based on the transmission data signal, and the second intensity modulating unit performs modulation based on a clock signal synchronized with the transmission data signal.

17. The optical transmission apparatus according to claim 1, further includes a light source which generates the input optical signal.
